(19) United States
(12) Patent Application Publication
(10) Pub. No.: US 2017/0132563 A1
(43) Pub. Date: May 11, 2017

(54) Delivery Area Management Method

(71) Applicant: Nippon Gas Co., Ltd., Tokyo (JP)

(72) Inventors: Shinji Wada, Tokyo (JP); Shingo Dekamo, Tokyo (JP)

(21) Appl. No.: 15/366,976

(22) Filed: Dec. 1, 2016

Related U.S. Application Data
(63) Continuation of application No. 14/405,865, filed on Dec. 5, 2014, now abandoned.

(30) Foreign Application Priority Data
Jun. 5, 2012 (JP) 2012-128090

(51) Int. Cl. G06Q 10/08; G06Q 10/06

(52) U.S. Cl. CPC G06Q 10/0834; G06Q 10/063116

(57) ABSTRACT

A system is provided for appropriately assigning LP gas cylinder deliveries to a limited and variable number of deliverymen. A total delivery count of a delivery base is assigned to respective deliverymen according to a rank of deliveryman. Postal codes are managed as the minimum unit of an area, and delivery data sorted by postal code is assigned to each deliveryman on the basis of the assigned delivery count. In this way, by dynamically dividing the delivery area of the delivery base into sub-areas made up of one or multiple postal codes, it is possible to conduct area management in accordance with the delivery capability of the deliverymen.

### TECHNICAL FIELD

The present invention relates to a delivery area management method for liquid petroleum (LP) gas cylinders. More specifically, the present invention relates to a delivery area management method for LP gas cylinders that divides a delivery area under the jurisdiction of a delivery base into groups, and assigns the divided delivery area to respective deliverymen in charge of delivery.

### BACKGROUND ART

The supply of LP gas is divided into importation from industrial gas-producing countries, and domestic production obtained as a by-product of the production process for petroleum products. Import terminals that store LP gas carried by tankers from industrial gas-producing countries, as well as petroleum refining bases, are respectively called primary terminals. LP gas is loaded onto coastal vessels and tank trucks, and shipped from primary terminals to secondary terminals, which are transit stations located along the coast or inland for LP gas shipping. Additionally, LP gas carried to secondary terminals is shipped to local LP gas filling stations, filled in LP gas cylinders at the filling stations, and delivered to individual homes and factories.

A delivery area is defined for each filling station, which acts as a delivery base. In the past, a delivery base supervisor divided the delivery area into fixed sub-areas, and assigned to each sub-area a deliveryman in charge of that sub-area.

At this point, the timing for delivering LP gas cylinders to multiple customers existing in a delivery area (such as homes and factories) is decided by predicting the remaining gas amount in a gas cylinder on the basis of information such as past gas usage history, meter data, and cylinder delivery history for each customer. For example, Patent Literature 1 discloses technology that subtracts a number of safety margin days for preventing running out of gas computed on the basis of the average daily usage for the current month for each customer from a predicted out-of-gas date, and sets the result as the delivery due date. According to such technology, it is possible to reduce the remaining gas amount in a gas cylinder to be exchanged, while also lowering the out-of-gas rate.

LP gas cylinders may be a single cylinder made up of only service cylinder, or two-cylinder set made up of service cylinder and reserve cylinder. For two-cylinder set, even if the LP gas in the service cylinders is completely consumed, LP gas is provided from the reserve set.

In other words, the timing for delivering LP gas cylinder includes an absolute condition for preventing running out of gas, but does not include the concept of fixed delivery according to a contract or delivery designated by the customer. The delivery of LP gas cylinders differs from the periodic delivery of goods such as newspapers and beverages according to a contract, or the delivery of packages according to a delivery date designated by the sender or recipient.

A fixed number of deliverymen work for each delivery base. As discussed above, in the past, the delivery base supervisor divided the delivery area into fixed sub-areas, and assigned to each sub-area a deliveryman in charge of that sub-area. For example, if deliverymen 1, 2, 3, 4, and 5, for a total of five deliverymen, work for a delivery base A, the supervisor divided the delivery area into five sub-areas a, b, c, d, and e, and assigned deliveryman 1 to sub-area a, deliveryman 2 to sub-area b, and so on, up to deliveryman 5 assigned to sub-area e.

When managing a delivery area in this way, a problem arises in which customers whose delivery is scheduled on the same day become clustered in a specific sub-area. This occurs because the timing for delivering an LP gas cylinder, although decided by predicting the remaining gas amount for each customer, has a consumption cycle that differs for each customer. Also, if a temporary substitute deliveryman is needed because a deliveryman takes a leave, there is a problem of how to allocate the sub-area handled by the deliveryman on leave. In this case, there is also the problem of reduced delivery efficiency due to allocating the sub-area handled by the deliveryman on leave to a substitute deliveryman who is unfamiliar with the area. Furthermore, every time there is a change in the number of associated deliverymen due to a decrease or increase in deliveryman, or every time a reevaluation of the sub-area definition is required because of factors such as an increase in new customers in a specific sub-area, the supervisor must redefine the sub-areas and reassign deliverymen into the newly defined sub-areas.

In addition to the problems discussed above, if customers with the same delivery due date become clustered in a specific sub-area, a secondary problem occurs in which delivery to a customer on the delivery due date may become impossible as a result of the number of deliveries exceeding the delivery capability of the deliveryman. Another secondary problem occurs in which, the deliverymen are frustrated by different workloads among sub-areas, a deliveryman is unable to freely take a leave because of the effects of the deliveryman's leave.

Accordingly, there is demand for a method of appropriately assigning LP gas cylinder deliveries having such characteristics to a limited and variable number of deliverymen.

### CITATION LIST

### Patent Literature

PTL 1: Japanese Patent Laid-Open No. H08-329159(1996)

### SUMMARY OF INVENTION

In order to solve the above problems, a delivery area management method according to the present invention is a method in a delivery area management system including a deliveryman data storage unit that stores a delivery base code identifying a delivery base for which a deliveryman works, a deliveryman code identifying a deliveryman, a rank expressing a count of gas cylinders that a deliveryman is able to deliver in a single day, and a surplus assignment coefficient, and a delivery data storage unit that stores a delivery base code uniquely identifying a delivery base, a customer ID, a postal code, a delivery due date, and an exchange count, the method being a method that assigns, to deliverymen, delivery data indicating that gas cylinders should be delivered on a predetermined delivery due date at a specific delivery base, the method comprising: extracting, by a data obtaining unit of the delivery area management system, on the basis of a delivery base code identifying the specific delivery base, deliveryman data of deliverymen working for the specific delivery base from the deliveryman data storage unit; obtaining, by the data obtaining unit, a deliverable count and a surplus assignable count of each deliveryman on the basis of the extracted deliveryman data, wherein the deliverable count is indicated by the rank included in the delivery data, and the surplus assignable count is calculated using the surplus assignment coefficient included in the deliveryman data according to a first formula

Surplus assignable count=(surplus assignment coefficient−1)*rank;

calculating, by the data obtaining unit, a total deliverable count and a total surplus assignable count of the specific delivery base, wherein the total deliverable count is calculated by summing the deliverable count of each deliveryman, and the total surplus assignable count is calculated by summing the surplus assignable count of each deliveryman; extracting, by the data obtaining unit, delivery data from the delivery data storage unit using the delivery base code and the predetermined delivery due date, and obtaining a total delivery count by summing the exchange count of the delivery data; comparing, by a count assigning unit of the delivery area management system, the total deliverable count and the total delivery count; if the total delivery count is less than or equal to the total deliverable count, assigning, by the count assigning unit, an assigned count to each deliveryman identified by the extracted deliveryman data according to a second formula

Assigned count=total delivery count/total deliverable count*deliverable count of deliveryman;

if the total delivery count is greater than the total deliverable count, assigning, by the count assigning unit, a tentative assigned count to each deliveryman identified by the extracted deliveryman data according to a third formula

Tentative assigned count={(total delivery count−total deliverable count)/total surplus assignable count*surplus assignable count of deliveryman}+deliverable count of deliveryman;

comparing, by the count assigning unit, the tentative assigned count to (the surplus assignable count+deliverable count of the deliveryman); if the tentative assigned count is greater than (the surplus assignable count+deliverable count of the deliveryman), setting, by the count assigning unit, the assigned count of the deliveryman to (the surplus assignable count+deliverable count of the deliveryman); if the tentative assigned count is less than or equal to than (the surplus assignable count+deliverable count of the deliveryman), setting, by the count assigning unit, the assigned count of the deliveryman to the tentative assigned count; sorting, by a delivery data assigning unit of the delivery area management system, the delivery data extracted by the data obtaining unit on the basis of the postal code of the delivery data; and assigning, by the delivery data assigning unit, the delivery data to a deliveryman according to the assigned count of the deliveryman.

According to the present invention, it is possible to conduct area management in accordance with the delivery capability of deliverymen by dividing the delivery area of a delivery base into sub-areas according to a rank of deliveryman. According to such area management, it is possible to solve the problem of the related art in which delivery of gas cylinder becomes clustered in a specific sub-area. Furthermore, it is also possible to resolve the secondary problem of a failure to complete the delivery schedule as a result of exceeding the delivery capability of the deliverymen, and it is also possible to resolve the secondary problem of discontent among deliverymen as a result of different workloads among sub-areas.

Also, according to the present invention, by dividing the delivery area of the delivery base into sub-areas using the leave data and a rank of deliveryman, it is possible to decide sub-areas while accounting for the load distribution within the area. According to such area management, it is possible to solve the problem of the related art of how to assign a sub-area handled by a deliveryman who is on leave. Furthermore, it is also possible to solve the secondary problem of a deliveryman being unable to freely take a leave because of the effects of the deliveryman's leave.

Furthermore, according to the present invention, on the basis of the assigned delivery data, it is possible to assign an optimal delivery truck according to the assigned count and sub-area.

### BRIEF DESCRIPTION OF DRAWINGS

FIG. 1 is a diagram illustrating a network topology according to an embodiment of the present invention;

FIG. 2 is a flowchart illustrating a series of processes by a delivery system according to an embodiment of the present invention;

FIG. 3 is a block diagram illustrating a configuration of a delivery server according to an embodiment of the present invention;

FIG. 4 is a diagram illustrating an example of information stored in a deliveryman data storage unit according to an embodiment of the present invention;

FIG. 5 is a diagram illustrating an example of information stored in an area data storage unit according to an embodiment of the present invention;

FIG. 6 is a diagram illustrating an example of information stored in a customer data storage unit according to an embodiment of the present invention;

FIG. 7 is a diagram illustrating an example of information stored in a delivery data storage unit according to an embodiment of the present invention;

FIG. 8 is a diagram illustrating an example of information stored in a leave data storage unit according to an embodiment of the present invention;

FIG. 9 is a diagram illustrating the relationship between FIG. 9A and FIG. 9B;

FIG. 9A is a flowchart illustrating a process of dividing a delivery area into groups and assigning deliverymen according to an embodiment of the present invention;

FIG. 9B is a flowchart illustrating a process of dividing a delivery area into groups and assigning deliverymen according to an embodiment of the present invention;

FIG. 10A is a diagram illustrating the relationship between a breakdown of a total delivery count for each postal code, and a deliveryman assigned to a delivery area identified by a postal code;

FIG. 10B is a diagram illustrating the relationship between a breakdown of a total delivery count for each postal code, and a deliveryman assigned to a delivery area identified by a postal code;

FIG. 10C is a diagram illustrating the relationship between a breakdown of a total delivery count for each postal code, and a deliveryman assigned to a delivery area identified by a postal code;

FIG. 10D is a diagram illustrating the relationship between a breakdown of a total delivery count for each postal code, and a deliveryman assigned to a delivery area identified by a postal code; and

FIG. 11 is a flowchart illustrating a process of dividing a delivery area into groups and assigning deliverymen according to an embodiment of the present invention.

### DESCRIPTION OF EMBODIMENTS

Hereinafter, a delivery system according to an embodiment of the invention will be described in detail and with reference to the attached drawings.

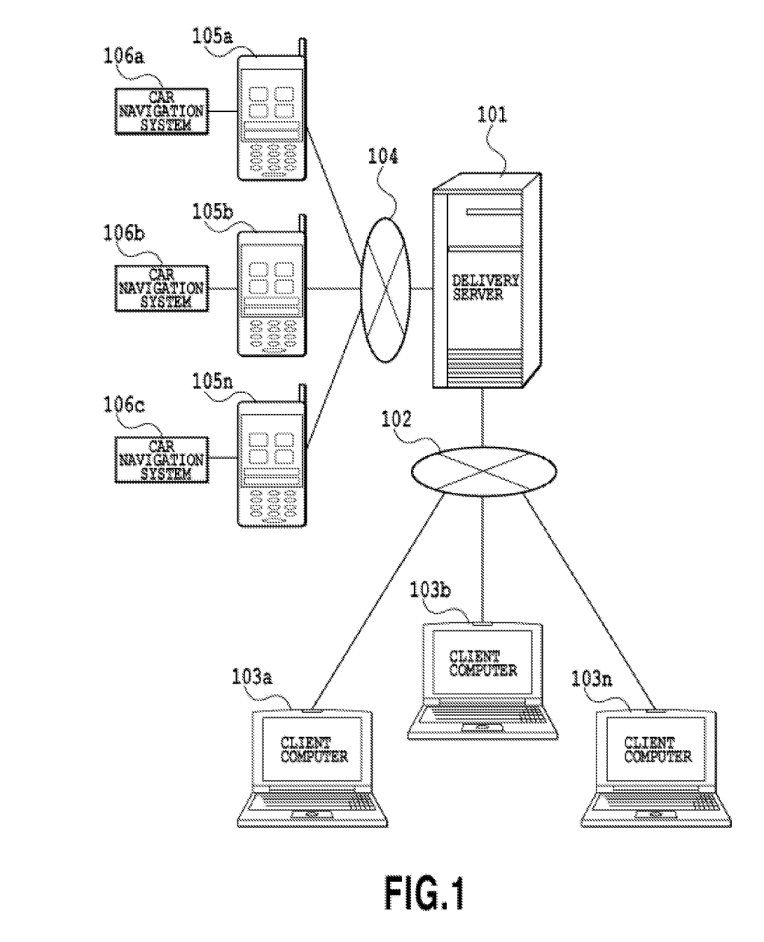

First, an overview of an LP gas cylinder delivery system will be described. FIG. 1 is a diagram illustrating a network topology according to an embodiment of the present invention. In FIG. 1, a delivery server 101 installed in a head office is configured to communicate, via a network 102, with multiple client computers 103a, 103b, . . . , 103n (hereinafter called the client computers 103) installed in delivery centers that centrally manage deliveries at each delivery base. In addition, the delivery server 101 is configured to communicate, via a network 104, with multiple mobile terminals 105a, 105b, . . . , 105n (hereinafter called the mobile terminals 105). Furthermore, the mobile terminals 105 are configured to communicate, via a short-range wireless communication technology (such as Bluetooth (registered trademark), for example), with multiple car navigation systems 106a, 106b, . . . , 106n (hereinafter called the car navigation systems 106) installed on board delivery trucks.

The delivery server 101 generates delivery data for each delivery base by aggregating data on gas cylinders to be delivered from the delivery base the next day, and data on gas cylinders that were scheduled to be delivered today but could not be delivered. After that, the delivery server 101 assigns the generated delivery data to each deliveryman working at the delivery base, and generates delivery schedule data per deliveryman.

In response to a delivery data request from a deliveryman's mobile terminal 105, the delivery server 101 also transmits the delivery schedule data per deliveryman corresponding to that deliveryman via the network 104. Additionally, the delivery server 101 receives delivery operation data (that is, data on gas cylinders that were delivered today) or undelivered task data (that is, data on gas cylinders that were not delivered today) by deliverymen from the mobile terminals 105, and uses the received data to update a storage unit included in the delivery server 101.

The client computer 103 is a terminal used by a user at a delivery center. The user connects to the delivery server 101 via the client computer 103 to perform work specific to delivery services, such as checking delivery status and transmitting a delivery data creation instruction. In the present embodiment, the client computer 103 is installed in the delivery center, but may also be installed in the head office like the delivery server 101, or installed in the delivery base.

The mobile terminal 105 is a terminal carried by each deliveryman at the delivery base. The deliveryman connects to the delivery server 101 via the mobile terminal 105, and transmits a delivery data request. After receiving delivery data, the deliveryman transmits customer address data (such as a postal code, address, and latitude/longitude information) included in the delivery data from the mobile terminal 105 to the car navigation system 106.

The car navigation system 106 is installed on board the delivery truck, and is used by the deliveryman. After receiving address data from the mobile terminal 105, the car navigation system 106 recognizes the multiple corresponding places, which may be used as data to support deliveries by the deliveryman.

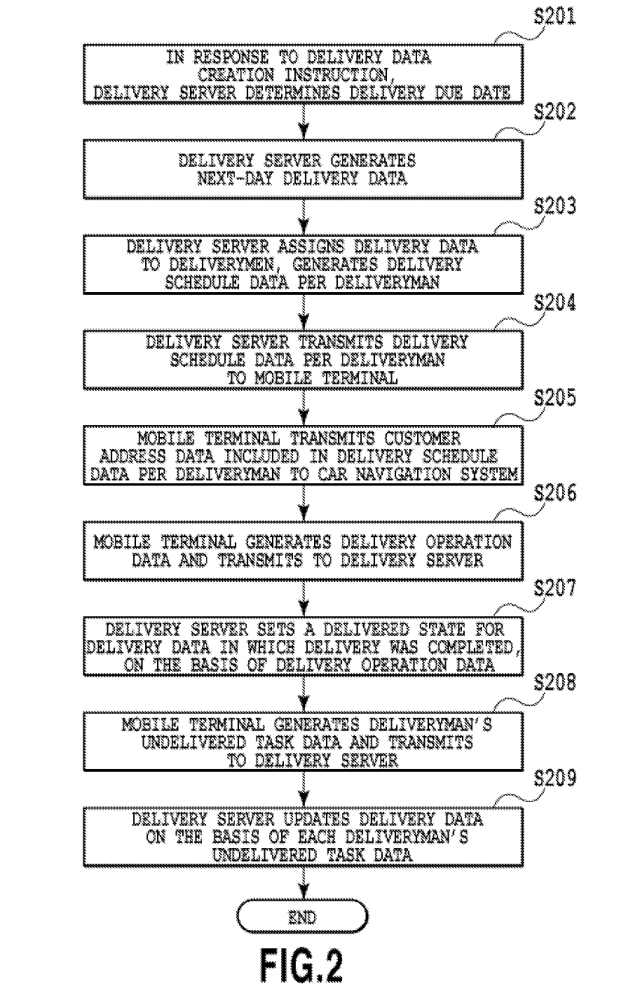

Next, the flowchart in FIG. 2 will be used to describe a series of processes conducted by a delivery system according to an embodiment.

Suppose that a user at a delivery center connects to the delivery server 101 via a client computer 103, and transmits a delivery data creation instruction. The delivery server 101 receives the delivery data creation instruction, predicts the remaining amount of the LP gas in the gas cylinder for customers under the jurisdiction of each delivery base on the basis of data for each customer (past gas usage history, meter data, and cylinder delivery history), and determines the next delivery due date (S201). The delivery server 101 generates delivery data for each delivery base by aggregating the data for customers whose delivery due date is the next day (such as a customer ID, a number of gas cylinders, and address data), and each delivery base's undelivered task data that could not be delivered from among the delivery data to be delivered today (such as a customer ID, a number of gas cylinders, and address data) (S202). Note that the generated delivery data is stored in the delivery server 101 for a fixed period, and the completion of deliveries by deliverymen may be managed on the basis of delivery operation data transmitted from the mobile terminals 105.

Next, the delivery server 101 assigns the delivery data generated for each delivery base to deliverymen working at that delivery base, and generates delivery schedule data per deliveryman (S203). The delivery server 101 extracts the data of deliverymen working at a base, and assigns delivery data on the basis of a predetermined standard. By completing the generation of delivery schedule data per deliveryman, preparations are complete for responding to a delivery data request from the mobile terminal 105. After generating the delivery schedule data per deliveryman, the delivery server 101 may transmit a message notifying the mobile terminal 105 of this state.

When a deliveryman connects to the delivery server 101 via their mobile terminal 105 and transmits a delivery data request, the delivery server 101 conducts an authentication process that checks identification information of the deliveryman. After that, the delivery server 101 transmits the delivery schedule data per deliveryman corresponding to the authenticated deliveryman to the mobile terminal 105 (S204).

After receiving the delivery schedule data per deliveryman, the deliveryman transmits customer address data (such as a postal code, address, and latitude/longitude information) included in the delivery schedule data per deliveryman from the mobile terminal 105 to the car navigation system 106 (S205). After receiving the address data from the mobile terminal 105, the car navigation system 106 recognizes the multiple corresponding places, and is able to decide a standard delivery route going through the multiple places.

The deliveryman, with the support of the car navigation system 106, makes deliveries to customers on the basis of the delivery schedule data per deliveryman. During delivery, the deliveryman generates delivery operation data via the mobile terminal 105, and transmits the delivery operation data to the delivery server 101 (S206). The delivery operation data includes a customer ID and the container barcodes of the exchanged gas cylinders. Note that a container barcode may be scanned by using a barcode reader function of the mobile terminal 105. At this point, during delivery, the deliveryman may perform work in addition to exchanging gas cylinders, such as reading the gas meter and inspecting the gas supply equipment. In this case, the deliveryman may generate delivery operation data including additional work data via the mobile terminal 105, and transmit the delivery operation data to the delivery server 101.

The delivery server 101 receives the delivery operation data, and on the basis of the received delivery operation data, sets a delivered state for the delivery data in which delivery was completed by the deliveryman (S207). If the delivery operation data includes additional work data, the delivery server 101 uses the additional work data to update the storage unit included in the delivery server 101.

Hypothetically, if delivery could not be completed on that day for a portion of customers included in the delivery schedule data per deliveryman, the deliveryman generates deliveryman's undelivered task data via the mobile terminal 105, and transmits the deliveryman's undelivered task data to the delivery server 101 (S208). In an embodiment, the deliveryman's undelivered task data may be configured to include a customer ID for which a delivery could not be completed.

The delivery server 101 receives each deliveryman's undelivered task data, and on the basis of the received each deliveryman's undelivered task data, updates the delivery data that was stored in S202 (S209). If deliveryman's undelivered task data includes a customer ID for which a delivery could not be completed, the customer ID is used to set an undelivered state for the customer ID included in the deliveryman's undelivered task data from among the delivery data. The updated delivery data may be used to create each delivery base's undelivered task data in S202 the following day.

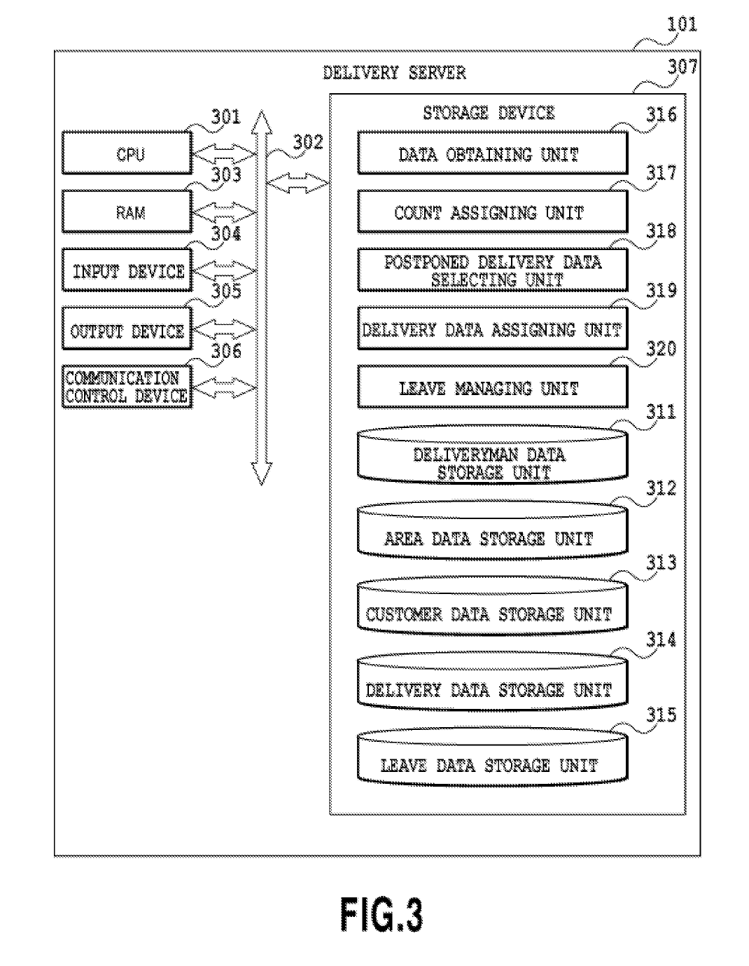

Next, a configuration of the delivery server 101 discussed above will be described in detail with reference to the block diagram in FIG. 3. Note that although FIG. 3 envisions a single computer system and illustrates only the necessary functional configuration, the delivery server 101 may also be configured as part of a multi-functional distributed system made up of multiple computer systems.

The delivery server 101 includes a configuration in which RAM 303, an input device 304, and output device 305, a communication control device 306, and a storage device 307 provided with a non-volatile storage medium (such as ROM or an HDD) are connected to a CPU 301 via a system bus 302. The storage device 307 is provided with a program storage area that stores software programs for performing the above functions, and a data storage area that stores information such as data obtained as needed and data as a processing result. The respective units of the program storage area described hereinafter are actually independent software programs, or sub-routines or components thereof. Additionally, the respective unit above performs respective functions by being called from the storage device 307 and loaded into a work area of the RAM 303 by the CPU 301, and by being sequentially executed while appropriately referencing information such as a database.

The data storage area is provided with a deliveryman data storage unit 311, an area data storage unit 312, a customer data storage unit 313, a delivery data storage unit 314, and a leave data storage unit 315. All are fixed storage areas reserved inside the storage device 307.

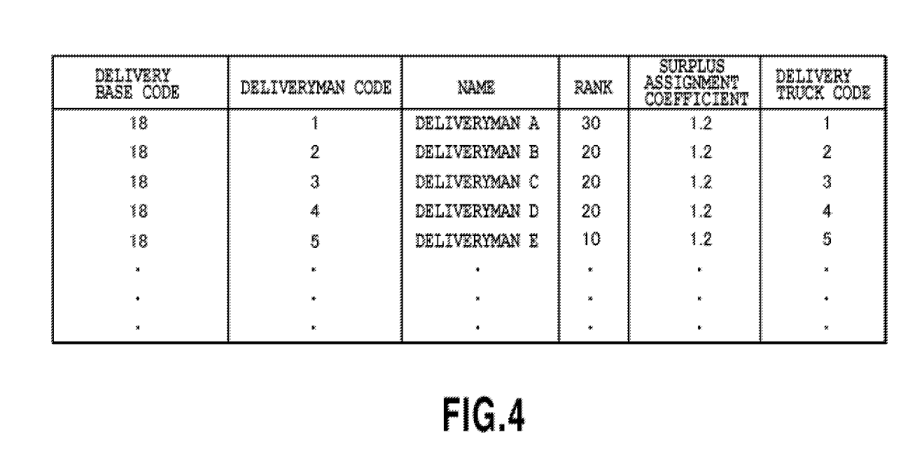

The deliveryman data storage unit 311 stores information related to deliverymen. In an embodiment, the deliveryman data storage unit 311 stores a delivery base code identifying the delivery base for which the deliveryman works, a deliveryman code identifying the deliveryman, a name, a rank, a surplus assignment coefficient, and a delivery truck code identifying the delivery truck, as illustrated in FIG. 4. The rank expresses the number of gas cylinders that the deliveryman is able to deliver in one day. The surplus assignment coefficient is a coefficient used to assign surplus to each deliveryman when the delivery count of gas cylinder included in the delivery data of the delivery base exceeds the total ranks of the deliverymen working for the delivery base.

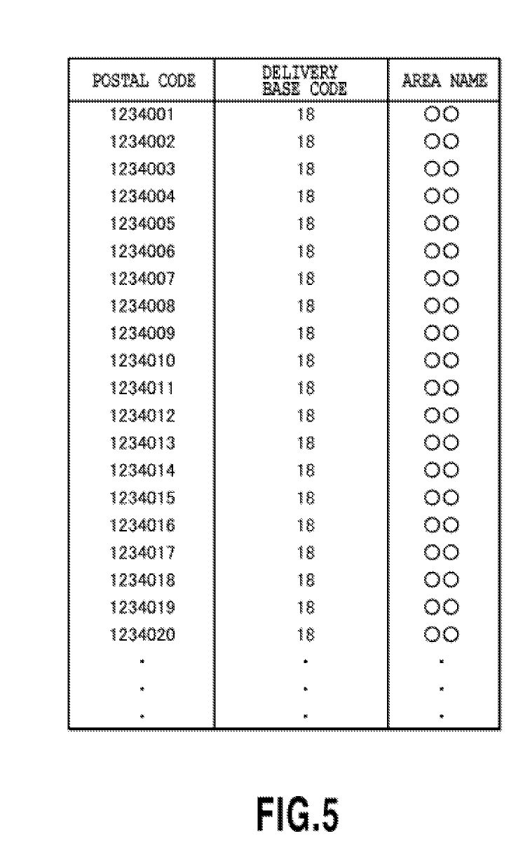

The area data storage unit 312 stores information related to delivery areas. In an embodiment, the area data storage unit 312 stores a postal code, delivery base code, and area name, and specifies the delivery base presiding over an area identified by a postal code, as illustrated in FIG. 5. In the present embodiment, the postal code is used as the minimum unit for identifying an area, but areas may also be managed by assigning unique identifiers in other units (such as cities, districts, or blocks). Also, in the case of a delivery base that presides over a comparatively large delivery area, the deliverymen working for the delivery base may also be managed by being divided into several groups. In the present embodiment, the delivery base presiding over an area identified by a postal code is specified, but if a delivery base is made up of multiple groups, the group presiding over an area identified by a postal code may be specified.

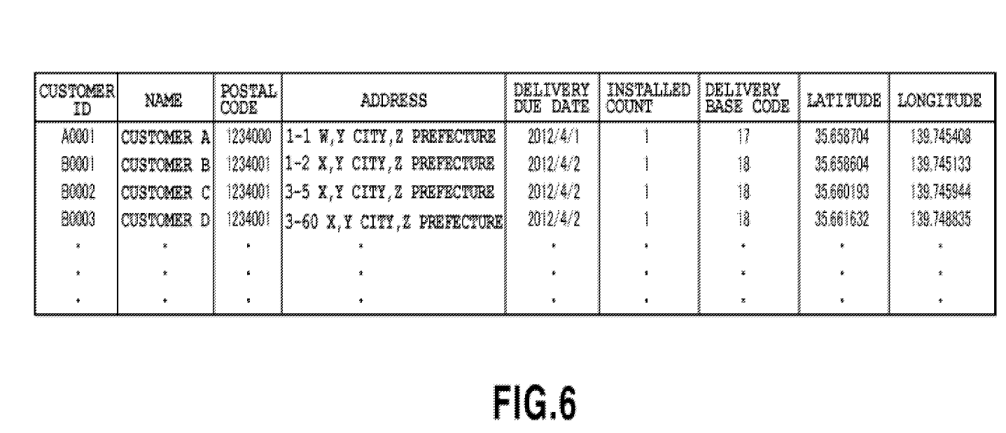

The customer data storage unit 313 stores information related to customers. In an embodiment, the customer data storage unit 313 includes a customer ID that uniquely identifies a customer, a name, a postal code, an address, a delivery due date, an installed count, a delivery base code, latitude, and longitude, as illustrated in FIG. 6. The delivery due date includes the delivery due date decided in step S201 of FIG. 2. The delivery base code includes the delivery base code in the area data storage unit 312, and specifies the delivery base presiding over the area identified by the customer's postal code.

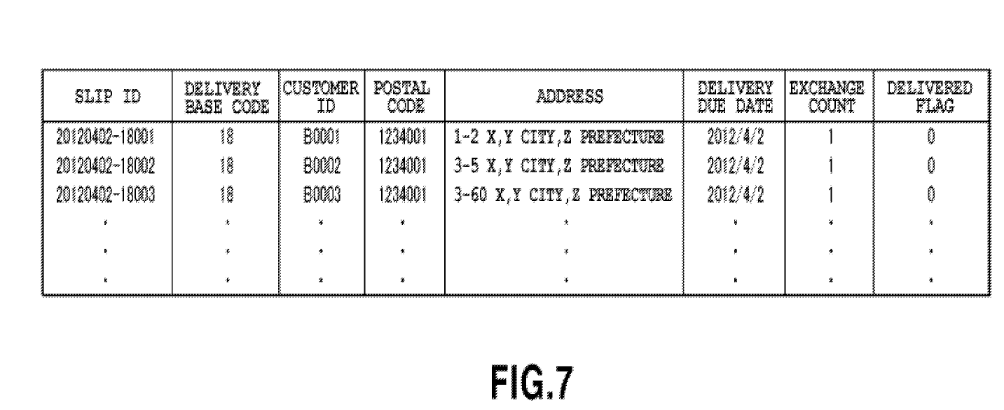

The delivery data storage unit 314 stores information related to deliveries. As illustrated in FIG. 7, the delivery data storage unit 314 includes a slip ID that uniquely identifies a delivery slip, a delivery base code, a customer ID, a postal code, an address, a delivery due date, an exchange count, and a delivered flag indicating whether or not delivery by a deliveryman is complete (“0” for the undelivered case, and “1” for the delivered case). For a customer in the delivery data storage unit 314, a customer ID, postal code, address, delivery due date, exchange count (the installed count in the customer data storage unit 313), and delivery base code are obtained from the customer data storage unit 313 and stored in the delivery data storage unit 314.

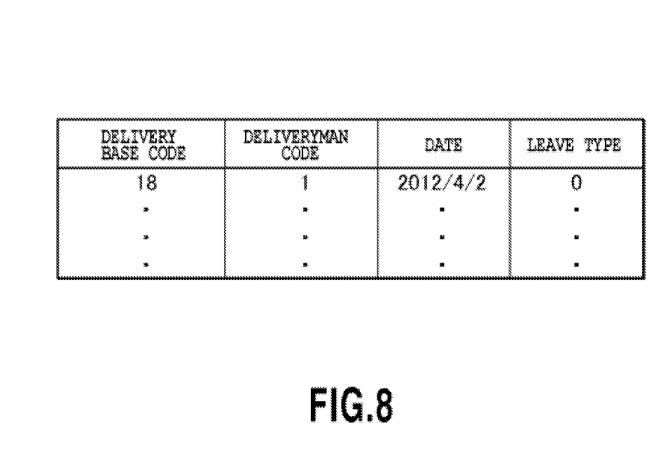

The leave data storage unit 315 stores information related to deliveryman's leave. In an embodiment, the leave data storage unit 315 includes a delivery base code, a deliveryman code, a date, and a leave type (“0” for the case of an all-day off, and “1” for the case of a half-day off), as illustrated in FIG. 8. The leave data storage unit 315 may be configured to store the deliveryman's leave information obtained from another server that includes attendance management data, for example.

The software programs stored in the program storage area include, when citing only examples related to the present invention, data obtaining unit 316, count assigning unit 317, postponed delivery data selecting unit 318, delivery data assigning unit 319, and leave managing unit 320.

The data obtaining unit 316 obtains predetermined data from a storage unit in the data storage area. First, on the basis of the delivery base code, deliveryman data of deliverymen working for the delivery base is extracted from the deliveryman data storage unit 311. After the deliveryman data is extracted, the data obtaining unit 316 obtains the deliverable count and the surplus assignable count of the deliverymen. After obtaining the deliverable count and the surplus assignable count for the extracted deliverymen, the total deliverable count and the total surplus assignable count for the delivery base is calculated. In addition, the data obtaining unit 316 searches the delivery data storage unit 314 using the delivery base code and the delivery due date, extracts delivery data that the delivery base should deliver the following day, and obtains the total delivery count for that delivery data.

The count assigning unit 317 assigns a delivery count to the deliverymen according to a predetermined formula. In the present embodiment, the total deliverable count and the total delivery count obtained by the data obtaining unit 316 are compared, and a different assignment process is conducted in the case when the total delivery count is less than or equal to the total deliverable count, and the case when the total delivery count is greater than the total deliverable count.

The postponed delivery data selecting unit 318 selects postponed delivery data from among the delivery data for which the next day's delivery is postponed when the total delivery count is greater than the total assigned count assigned to the deliverymen. In the present embodiment, “null” indicating an empty value is set for the delivered flag in the delivery data storage unit corresponding to the selected postponed delivery data.

The delivery data assigning unit 319 assigns delivery data to deliverymen. The delivery data assigning unit 319 sorts delivery data that the delivery base should deliver the following day extracted by the data obtaining unit, on the basis of the postal code of the delivery data. Subsequently, the delivery data assigning unit 319 assigns the sorted delivery data to deliverymen on the basis of the assigned count assigned to each deliveryman by the count assigning unit 317.

The leave managing unit 320 searches the leave data storage unit 315 using the delivery base code and the deliveryman code, and extracts the leave data of a deliveryman who takes tomorrow off. If leave data exists, the leave managing unit 320 determines the leave type of the extracted leave data, and conducts a predetermined process according to the leave type. In the case of an all-day off, the leave managing unit 320 removes the deliveryman data of the deliveryman identified by the deliveryman code included in the leave data from the deliveryman data extracted by the data obtaining unit 316. Meanwhile, in the case of a half-day off, the leave managing unit 320 temporarily halves the rank in the deliveryman data of the deliveryman identified by the deliveryman code included in the leave data in the deliveryman data extracted by the data obtaining unit 316.

### First Embodiment

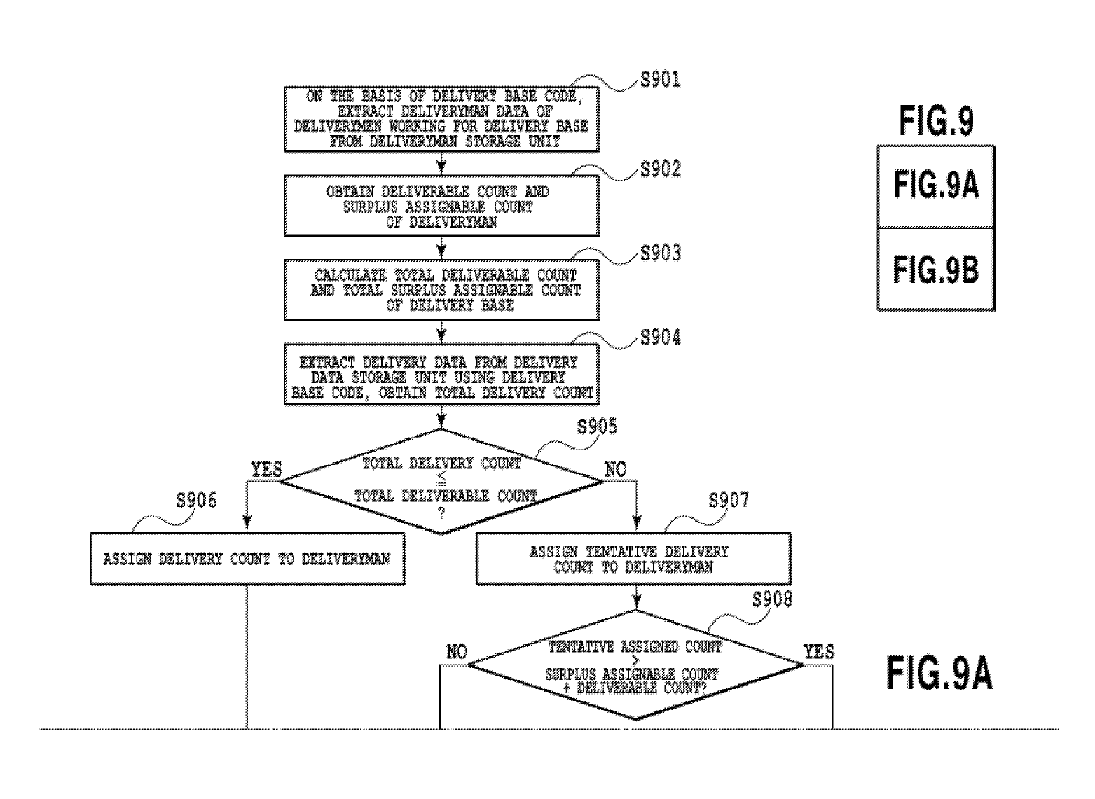

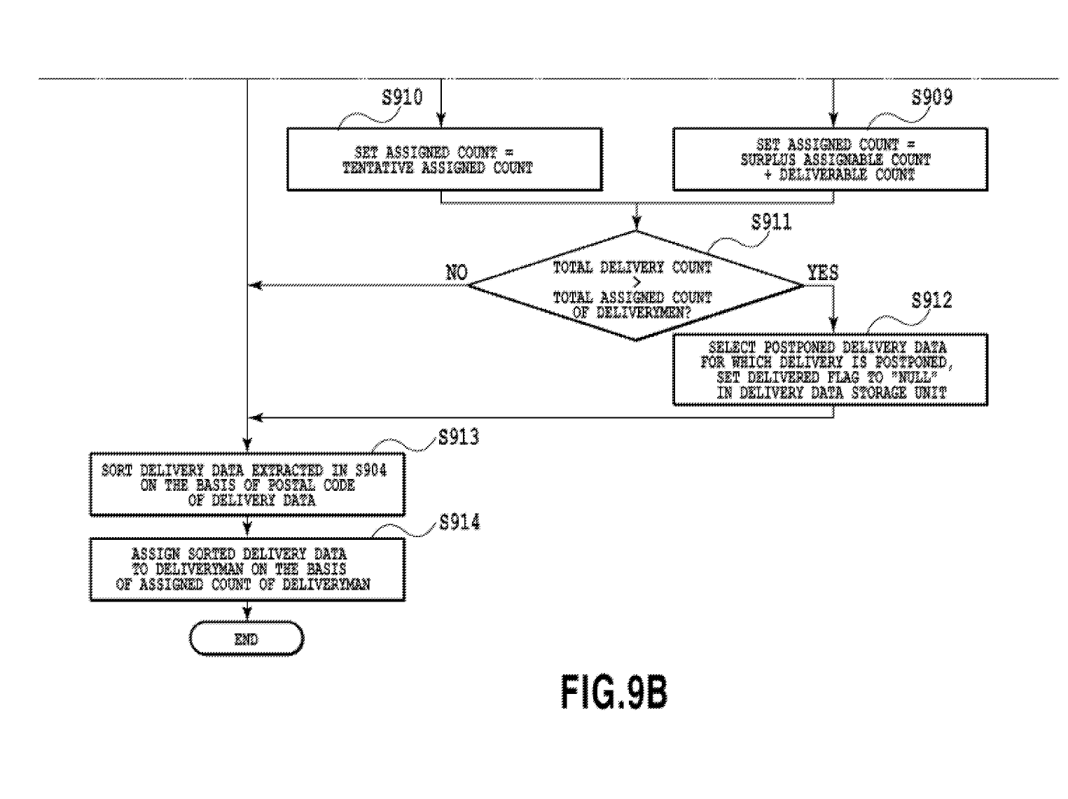

Next, the delivery data assignment process according to an embodiment indicated in step S203 of FIG. 2 will be described in detail with reference to the flowchart in FIGS. 9A and 9B. Suppose that a delivery base X presides over the postal codes from 1234001 to 1234020 as a delivery area, and employs a total of five deliverymen A, B, C, D, and E. Also, suppose that delivery data including 100 gas cylinders as illustrated in FIG. 7 is generated as the delivery data for the following day for the delivery base X.

The data obtaining unit 316 of the delivery server 101, on the basis of the delivery base code that identifies the delivery base, extracts deliveryman data of deliverymen working for the delivery base from the deliveryman data storage unit 311 (S901). In the present embodiment, on the basis of the delivery base code (18) identifying the delivery base X, deliveryman data of the deliverymen A, B, C, D, and E is extracted from the deliveryman data storage unit 311. After the deliveryman data is extracted, the data obtaining unit 316 obtains the deliverable count and the surplus assignable count of the deliverymen (S902). In the present embodiment, the deliverable count of a deliveryman is indicated by the rank included in the deliveryman data. The surplus assignable count of a deliveryman is calculated according to the following formula using the surplus assignment coefficient and the rank included in the deliveryman data.

Surplus assignable count=(surplus assignment coefficient−1)*rank (1)

In the present embodiment, the surplus assignable counts of the deliverymen A, B, C, D, and E are 6 cylinders, 4 cylinders, 4 cylinders, 4 cylinders, and 2 cylinders, respectively.

After obtaining the deliverable count and the surplus assignable count for all extracted deliverymen, the data obtaining unit 316 calculates the total deliverable count and the total surplus assignable count for the delivery base (S903). In the present embodiment, the ranks included in the deliveryman data for the deliverymen A, B, C, D, and E are summed to calculate a total deliverable count of 100 cylinders, while the surplus assignable counts of the deliverymen calculated in S902 are summed to calculate a total surplus assignable count of 20 cylinders. Next, the data obtaining unit 316 searches the delivery data storage unit 314 using the delivery base code, extracts delivery data that the delivery base should deliver the following day, and obtains the total delivery count with the addition of the exchange count for that delivery data (S904). In the present embodiment, suppose that the current process is executed on Apr. 1, 2012, and on the basis of the delivery base code (18), 100 cylinders is obtained as the total delivery count that the delivery base X should deliver on Apr. 2, 2012.

The count assigning unit 317 of the delivery server 101 compares the total deliverable count obtained in step S903 to the total delivery count obtained in step S904 (S905). If the total delivery count is less than or equal to the total deliverable count, the process proceeds to step S906, whereas if the total delivery count is greater than the total deliverable count, the process proceeds to step S907. In the present embodiment, since the total delivery count is 100 cylinders and the total deliverable count is also 100 cylinders, the process proceeds to step S906.

In step S906, the count assigning unit 317 assigns a delivery count to the deliverymen according to the following formula.

Assigned count=total delivery count/total deliverable count*deliverable count of deliveryman (2)

In the present embodiment, the above formula becomes total delivery count (100)/total deliverable count (100)*deliverable count of deliveryman, and each deliveryman is assigned a number of cylinders equal to his or her own rank. As Formula 2 demonstrates, if the total delivery count is less than or equal to the total deliverable count, each deliveryman is assigned a number of cylinders less than or equal to his or her own rank according to Formula 2. Note that when the assigned count is not an integer value, a rounding-up process is conducted to produce an integer value.

In step S907, the count assigning unit 317 assigns a tentative delivery count to the deliverymen according to the following formula.

$$Tentative assigned count = \{ \frac{( total delivery count - total deliverabl e count )}{total surplus assignable count} \times surplus assignable count of deliveryma n \} + deliverabl e count of deliveryma n \qquad ( 3 )$$

For example, if the total delivery count is 110 cylinders, the deliverymen A, B, C, D, and E are assigned 33 cylinders, 22 cylinders, 22 cylinders, 22 cylinders, and 11 cylinders, respectively.

Next, the count assigning unit 317 compares the tentative assigned count to (surplus assignable count+deliverable count of deliveryman) (S908). If the tentative assigned count is greater than (surplus assignable count+deliverable count of deliveryman), the assigned count is set equal to (surplus assignable count+deliverable count of deliveryman) (S909). If the tentative assigned count is less than or equal to than (surplus assignable count+deliverable count of deliveryman), the assigned count is set equal to the tentative assigned count (S910).

In the foregoing steps, an assigned count is decided for each deliveryman. The postponed delivery data selecting unit 318 of the delivery server 101 compares the total delivery count to the total assigned count assigned to the deliverymen (S911). If the total delivery count is greater than the total assigned count assigned to the deliverymen, postponed delivery data for which the next day's delivery is postponed may be selected from among the delivery data (S912). In the present embodiment, the postponed delivery data selecting unit 318 sets “null” which indicates an empty value for the delivered flag in the delivery data storage unit 314 corresponding to the selected postponed delivery data.

In the present embodiment, a flag (not illustrated) indicating whether or not a customer has a two-cylinder set may be stored in the customer data storage unit 313 and the delivery data storage unit 314, and the delivery data for customers with two-cylinder set may be selected as postponed delivery data. Additionally, in another embodiment, a remaining gas amount predicted in step S201 of FIG. 2 may be stored in the customer data storage unit 313 and the delivery data storage unit 314, and the data of customers with higher predicted remaining gas amounts may also be selected as postponed delivery data. Persons skilled in the art will understand that postponed delivery data may be selected by another standard (such as the delivery due date being the following day), or by a combination of these standards.

Next, the delivery data is assigned to the deliverymen.

The delivery data assigning unit 319 of the delivery server 101 sorts the delivery data extracted by the data obtaining unit 316 on the basis of the postal code of the delivery data (S913). By assigning delivery data sorted in this way to the deliverymen, customers who are clustered close together geographically may be assigned to each deliveryman.

Finally, the delivery data assigning unit 319 assigns the sorted delivery data to the deliverymen on the basis of the assigned count of each deliveryman (S914). Note that by assigning delivery data while skipping data in which “null” is set in the delivered flag, the postponed delivery data is not assigned to the deliverymen.

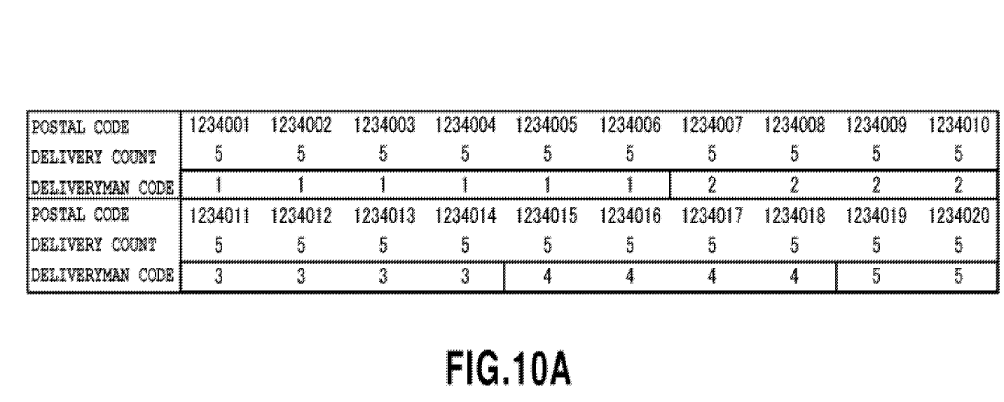

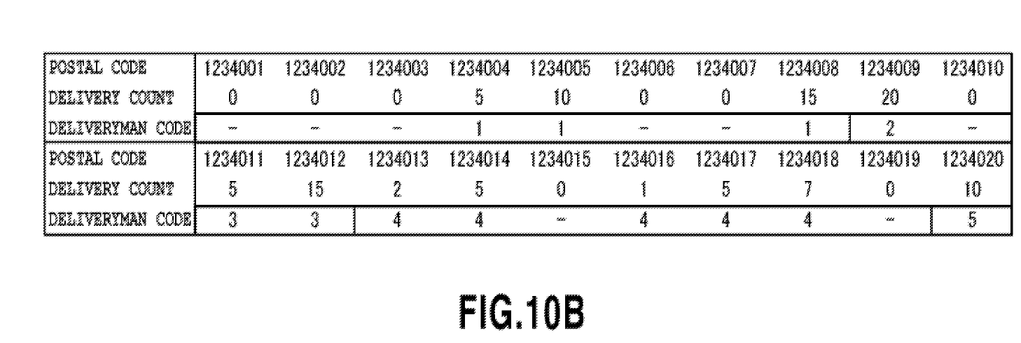

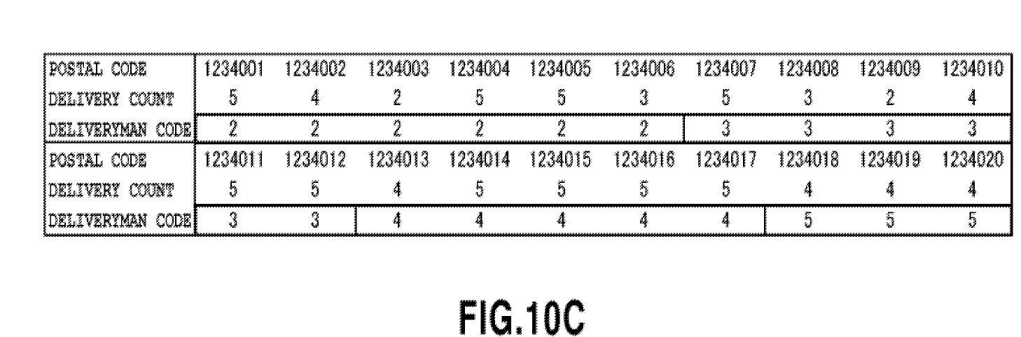

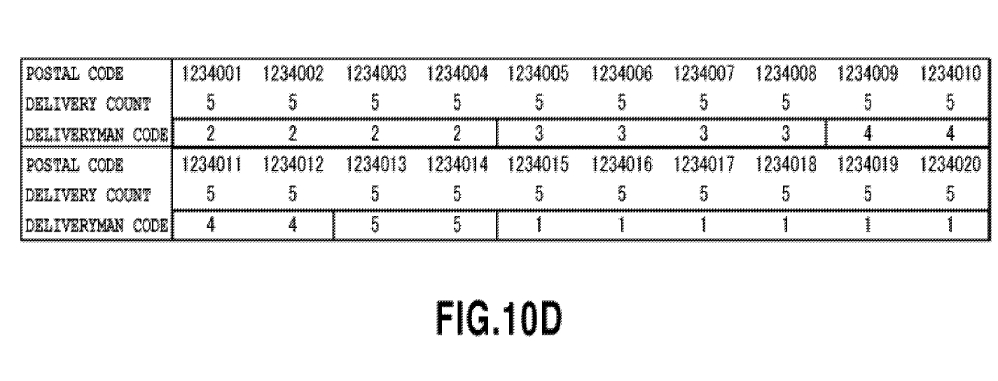

FIGS. 10A to 10D illustrate relationships between a breakdown of a total delivery count for each postal code, and a deliveryman assigned to a delivery area identified by a postal code in the present embodiment. FIG. 10A illustrates an example in which the total delivery count is distributed evenly over the delivery area for each postal code. FIG. 10B illustrates an example in which the total delivery count is interspersed over the delivery area of the delivery base.

When conducting deliveryman assignment according to the present embodiment, in FIG. 10A, the delivery area of the delivery base is divided into a sub-area a of the postal codes from 1234001 to 1234006 (handled by deliveryman A), a sub-area b of the postal codes from 1234007 to 1234010 (handled by deliveryman B), a sub-area c of the postal codes from 1234011 to 1234014 (handled by deliveryman C), a sub-area d of the postal codes from 1234015 to 1234018 (handled by deliveryman D), and a sub-area e of the postal codes from 1234019 to 1234020 (handled by deliveryman E). In contrast, in FIG. 10B, the delivery area of the delivery base is divided into a sub-area a of the postal codes from 1234001 to 1234008 (handled by deliveryman A), a sub-area b of the postal codes from 1234009 to 1234010 (handled by deliveryman B), a sub-area c of the postal codes from 1234011 to 1234012 (handled by deliveryman C), a sub-area d of the postal codes from 1234013 to 1234019 (handled by deliveryman D), and a sub-area e of the postal code 1234020 (handled by deliveryman E).

At this point, as an example based on FIG. 10A, consider the case of assigning deliverymen by dividing the delivery area of the delivery base into fixed sub-areas as in the related art. In other words, suppose that the delivery area of the delivery base X is divided into a sub-area a of the postal codes from 1234001 to 1234006 (handled by deliveryman A), a sub-area b of the postal codes from 1234007 to 1234010 (handled by deliveryman B), a sub-area c of the postal codes from 1234011 to 1234014 (handled by deliveryman C), a sub-area d of the postal codes from 1234015 to U.S. Pat. No. 1,234,018 (handled by delivery man D), and a sub-area e of the postal codes from 1234019 to 1234020 (handled by deliveryman E), irrespective of the breakdown of the total delivery count.

In this case, the deliverymen A (rank 30), B (rank 20), C (rank 20), D (rank 20), and E (rank 10) are assigned 15 cylinders, 35 cylinders, 27 cylinders, 13 cylinders, and 10 cylinders, respectively, which leads directly to the various problems discussed earlier.

Thus, according to the present invention, it is possible to conduct area management in accordance with the delivery capability of deliverymen by dividing the delivery area of a delivery base into sub-areas according to a rank of deliveryman. According to such area management, it is possible to solve the problem of the related art in which delivery of gas cylinder becomes clustered in a specific sub-area. In addition, it is also possible to resolve the secondary problem of a failure to complete the delivery schedule due to exceeding the delivery capability of the deliverymen. Furthermore, it is also possible to resolve the secondary problem of discontent among deliverymen because of different workloads among sub-areas.

### Second Embodiment

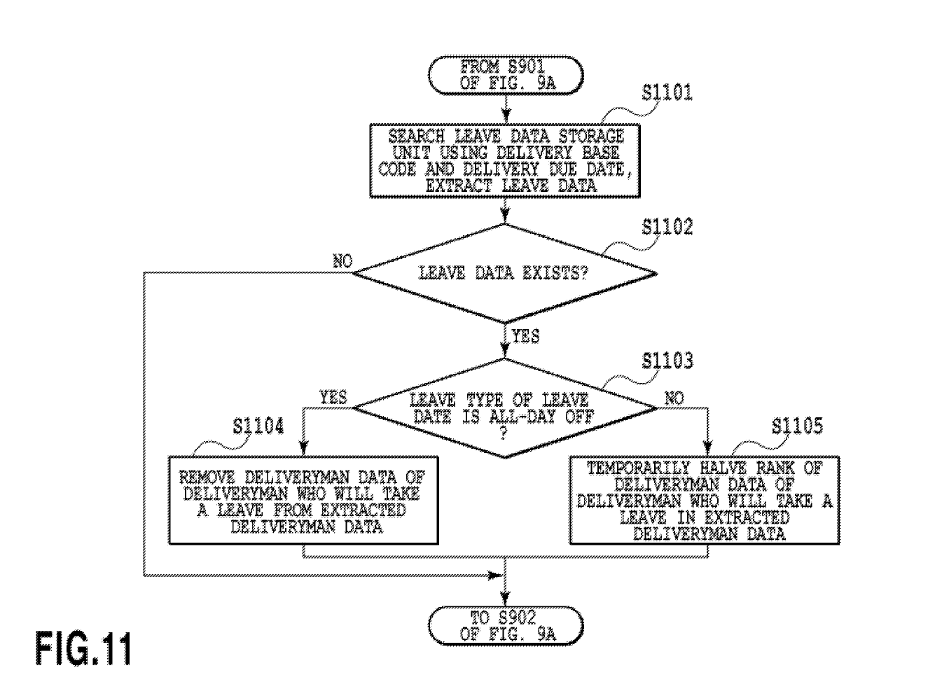

Next, a second embodiment of the delivery data assignment process will be described with reference to the flowcharts in FIGS. 9A, 9B, and 11. In the second embodiment, suppose that a delivery base X presides over the postal codes from 1234001 to 1234020 as a delivery area, and employs a total of five deliverymen A, B, C, D, and E, similarly to the first embodiment. Also, suppose that delivery data including 100 gas cylinders as illustrated in FIG. 7 is generated as the delivery data for the following day (Apr. 2, 2012) for the delivery base X. Herein, in the present embodiment, the deliveryman A is scheduled to take an all-day off on the following day. Hereinafter, description of the portions that are the same as the first embodiment will be reduced or omitted.

The data obtaining unit 316, on the basis of the delivery base code (18) identifying the delivery base X, extracts deliveryman data of the deliverymen A, B, C, D, and E from the deliveryman data storage unit 311 (S901). Next, in the present embodiment, the leave managing unit 320 searches the leave data storage unit 315 using the delivery base code, and extracts the leave data of a deliveryman who takes tomorrow off (S1101). In the present embodiment, the leave data of the deliveryman A is extracted. The leave managing unit 320 determines whether or not leave data exists (S1102), and proceeds to step S1103 if leave data exists, and proceeds to step S902 if leave data does not exist. In the present embodiment, the process proceeds to step S1103.

In step S1103, the leave managing unit 320 determines the leave type of the extracted leave data, and proceeds to step S1104 in the case of a value indicating an all-day off, and proceeds to step S1105 in the case of a value indicating a half-day off. In step S1104, the leave managing unit 320 removes the deliveryman data of the deliveryman identified by the deliveryman code included in the leave data from the deliveryman data extracted in step S901. In the present embodiment, the deliveryman data of the deliveryman A identified by the deliveryman code (3) included in the leave data is removed.

In step S1105, the leave managing unit 320 temporarily halves the rank in the deliveryman data of the deliveryman identified by the deliveryman code included in the leave data in the deliveryman data extracted in step S1101. For example, if the deliveryman A having a rank of 30 takes a half-day off, the rank is temporarily set to 15.

If leave data is multiply extracted, the processing from steps S1103 to S1105 is conducted for each piece of leave data. Note that the deliveryman data removal and rank halving in steps S1104 and S1105 are not permanent processes conducted on the deliveryman data storage unit 311, but rather processes conducted on data that is obtained from the deliveryman data storage unit 311 and loaded into the RAM 303.

In step S902, the data obtaining unit 316 uses the ranks in the deliveryman data finalized in the above step to obtain the deliverable count and the surplus assignable count of each deliveryman. Next, the data obtaining unit 316 calculates the total delivery count and the total deliverable count of the delivery base (S903). In the present embodiment, the ranks included in the deliveryman data for the deliverymen B, C, D, and E are summed to calculate a total deliverable count of 70 cylinders, while the surplus assignable counts calculated in S902 are summed to calculate a total surplus assignable count of 14 cylinders. Thereafter, the process is similar to First Embodiment. The data obtaining unit 316 searches the delivery data storage unit 314 using the delivery base code (18), and obtains 100 cylinders as the total delivery count that the delivery base should deliver the following day (S904).

The count assigning unit 317 compares the total deliverable count (70) calculated in step S903 to the total delivery count (100) obtained in step S904 (S905), and proceeds to step S907.

In step S907, the count assigning unit 317 assigns tentative assigned counts of 29 cylinders, 29 cylinders, 29 cylinders, and 15 cylinders to the deliverymen B, C, D, and E, respectively. Subsequently, the count assigning unit 317 compares each tentative assigned count to (surplus assignable count+deliverable count) (S908). Since the tentative assigned counts are greater, the count assigning unit 317 proceeds to 5909, and assigns 24 cylinders, 24 cylinders, 24 cylinders, and 12 cylinders to the deliverymen B, C, D, and E, respectively.

The postponed delivery data selecting unit 318 compares the total delivery count (100 cylinders) to the total assigned count (84 cylinders) assigned to the deliverymen (S911). Since the total delivery count is greater, the process proceeds to S912, and the postponed delivery data selecting unit 318 selects postponed delivery data for which the next day's delivery is postponed from among the delivery data. The postponed delivery data selecting unit 318 sets “null” to indicate an empty value for the delivered flag in the delivery data storage unit 314 corresponding to the selected postponed delivery data.

The delivery data assigning unit 319 sorts delivery data that the delivery base should deliver the following day extracted by the data obtaining unit 316 in step S904, on the basis of the postal code of the delivery data (S913). Finally, the delivery data assigning unit 319 assigns the sorted delivery data to the deliverymen on the basis of the assigned count assigned to each deliveryman (S914). Note that assignment is skipped for data in which “null” is set in the delivered flag.

FIG. 10C illustrates the relationship between a breakdown of a total delivery count for each postal code, and a deliveryman assigned to a delivery area identified by a postal code in the second embodiment. By conducting deliveryman assignment according to the present embodiment, the delivery area of the delivery base is divided into a sub-area a of the postal codes from 1234001 to 1234006 (handled by deliveryman B), a sub-area b of the postal codes from 1234007 to 1234012 (handled by deliveryman C), a sub-area c of the postal codes from 1234013 to 1234017 (handled by deliveryman D), and a sub-area d of the postal codes from 1234018 to 1234020 (handled by deliveryman E).

Herein, as an example based on FIG. 10A, if the delivery area of the delivery base is divided into fixed sub-areas and deliverymen are assigned as in the related art, a problem occurs in how to assign the delivery data of the 30 cylinders to be delivered in the sub-area handled by deliveryman A (postal codes 1234001 to 1234006). For example, if all of the delivery data is assigned to deliveryman B in charge of the neighboring sub-area, the assigned count assigned to deliveryman B becomes 50 cylinders, which greatly exceeds the delivery capability of deliveryman B. Also, if all of the delivery data handled by the deliveryman A is postponed from the following day, there is a high likelihood that the assigned count for deliveryman A on the postponed day will greatly exceed the delivery capability of deliveryman A.

Thus, according to the present invention, by dividing the delivery area of the delivery base into sub-areas using the leave data and a rank of deliveryman, it is possible to decide sub-areas while accounting for the load distribution within the area. According to such area management, it is possible to solve the problem of the related art of how to assign a sub-area handled by a deliveryman who is on leave. Furthermore, it is also possible to solve the secondary problem of a deliveryman being unable to freely take a leave because of the effects of the deliveryman's leave.

### Third Embodiment

Next, a third embodiment of the delivery data assignment process will be described with reference to the flowchart in FIGS. 9A and 9B as well as the diagrams in FIGS. 10A to 10D. In the third embodiment, suppose that a delivery base X presides over the postal codes from 1234001 to 1234020 as a delivery area, and employs a total of five deliverymen A, B, C, D, and E, similarly to the first embodiment. Also, suppose that delivery data including 100 gas cylinders as illustrated in FIG. 7 is generated as the delivery data for the following day (Apr. 2, 2012) for the delivery base X. At this point, in the present embodiment, the deliveryman data storage unit 311 also stores an allocation order in addition to the data illustrated in FIG. 4. The allocation order indicates the order in which to assign delivery data to deliverymen working for the delivery base.

The delivery server 101 conducts a process according to the flowchart in FIGS. 9A and 9B. In step S906, similarly to the first embodiment, the deliverymen A, B, C, D, and E are assigned 30 cylinders, 20 cylinders, 20 cylinders, 20 cylinders, and 10 cylinders, respectively. When the delivery data assigning unit 319 assigns delivery data to the deliverymen via step S913 (S914), in the present embodiment, suppose that the allocation order of the deliverymen A, B, C, D, and E is configured to 1, 2, 3, 4, 5 on Apr. 1, 2012. In addition, suppose that the total delivery count is distributed evenly over the delivery area for each postal code, as illustrated in FIG. 10A.

In the present embodiment, the delivery data assigning unit 319 sorts the deliveryman data using the allocation order of the deliverymen, and assigns delivery data to the deliverymen in descending allocation order. The assignment result is as indicated in FIG. 10A.

Finally, in the present embodiment, the delivery data assigning unit 319 updates the allocation order in the deliveryman data storage unit 311. In the present embodiment, the deliveryman who was first place in the previous allocation order is set to last place, and the places of the other deliverymen are decremented by 1 in the allocation order.

On the following day of Apr. 2, 2012, suppose that delivery data including 100 gas cylinders as illustrated in FIG. 7 is generated as the delivery data for the following day (Apr. 3, 2012) for the delivery base X. The delivery server 101 conducts a process according to the flowchart in FIGS. 9A and 9B. In step S906, similarly to the first embodiment, the deliverymen A, B, C, D, and E are assigned 30 cylinders, 20 cylinders, 20 cylinders, 20 cylinders, and 10 cylinders, respectively. When the delivery data assigning unit 319 assigns delivery data to the deliverymen via step S913 (S914), the allocation order of the deliverymen A, B, C, D, and E is configured to 5, 1, 2, 3, 4 on Apr. 2, 2012. In addition, suppose that the total delivery count is distributed evenly over the delivery area for each postal code, as illustrated in FIG. 10D.

When conducting deliveryman assignment according to the present embodiment, the delivery data is assigned to the deliverymen as illustrated in FIG. 10D. In an embodiment that does not use the allocation order, the sub-areas into which the delivery area is grouped change dynamically, as illustrated in FIGS. 10A and 10B, for example. However, deliveryman A is always in charge of an area of smaller postal codes while deliveryman E is always in charge of an area of larger postal codes, and deliveryman A does not have an opportunity to be in charge of an area of larger postal codes. On the other hand, in the present embodiment, by varying the order in which to assign delivery data to deliverymen in addition to dynamically deciding the sub-areas, each deliveryman gets an opportunity to be in charge of the entire delivery area of the delivery base.

Thus, according to the present invention, by assigning delivery data to deliverymen using an allocation order of the deliverymen, it is possible to grant to each deliveryman working for the delivery base an opportunity to be in charge of the entire delivery area of the delivery base. According to such area management, it is possible to solve the problem of the related art of lowered delivery efficiency due to assigning the sub-area handled by a deliveryman who is on leave to a substitute deliveryman with no familiarity with the area. Furthermore, it is also possible to resolve the secondary problem of discontent among deliverymen that may occur as a result of different conditions among sub-areas, such as how close or far a sub-area exists from the delivery base.

(Other)

Note that in the foregoing embodiments, a fixed delivery truck is assigned to each deliveryman, as illustrated in FIG. 4. In another embodiment, a delivery truck may be assigned on the basis of the delivery data assigned according to an embodiment of the present invention. For example, a delivery truck having an optimal cylinder load capacity may be assigned on the basis of the assigned count. In addition, on the basis of the assigned sub-area, a delivery truck with a narrow width may be assigned to a deliveryman in charge of a sub-area with many narrow streets, for example.

1-6. (canceled)

7. A method implemented for managing a delivery area in which a deliveryman deliver a gas cylinder filled with gas to a gas customer who receives a gas supply, the method comprising:
extracting, on the basis of a specific delivery base identification code, deliveryman data from a deliveryman data storage unit that stores a delivery base identification code, a deliveryman identification code, a deliverable count of gas cylinders, and a surplus assignment coefficient;
extracting, leave data from a leave data storage unit on the basis of the specific delivery base identification code and a predetermined delivery due date, wherein the leave data storage unit stores a delivery base identification code, a deliveryman identification code, a scheduled leave date, and a leave type indicating one of an all-day off or a half-day off;
if the leave type of the extracted leave data indicates an all-day off, removing deliveryman data including a deliveryman identification code matching a deliveryman identification code included in the leave data from the extracted deliveryman data;
if the leave type of the extracted leave data indicates a half-day off, halving the deliverable count of deliveryman data including a deliveryman identification code matching a deliveryman identification code included in the leave data in the extracted deliveryman data;
obtaining the deliverable count and a surplus assignable count of each deliveryman on the basis of the extracted deliveryman data, wherein the surplus assignable count is computed according to a first formula
surplus assignable count=(surplus assignment coefficient−1)*deliverable count;
calculating a total deliverable count by summing the obtained deliverable count, and calculating a total surplus assignable count by summing the obtained surplus assignable count;
extracting delivery data from a delivery data storage unit on the basis of the specific delivery base identification code and the predetermined delivery due date, and obtaining a total delivery count by summing the exchange count of the extracted delivery data, wherein the delivery data storage unit stores a delivery base identification code, a customer ID, a postal code, a customer address, a delivery due date, and an exchange count;
comparing the calculated total deliverable count and the obtained total delivery count;
as a result of the comparison, if the obtained total delivery count is less than or equal to the calculated total deliverable count, calculating an assigned count for each deliveryman according to a second formula
assigned count=total delivery count/total deliverable count*deliverable count of deliveryman;
as a result of the comparison, if the obtained total delivery count is greater than the calculated total deliverable count, calculating a tentative assigned count for each deliveryman according to a third formula
tentative assigned count={(total delivery count−total deliverable count)/total surplus assignable count*surplus assignable count of deliveryman}+deliverable count of deliveryman;
comparing the calculated tentative assigned count to (the surplus assignable count+deliverable count of the deliveryman);
as a result of the comparison, if the calculated tentative assigned count is greater than (the surplus assignable count+deliverable count of the deliveryman), setting the calculated assigned count to (the surplus assignable count+deliverable count of the deliveryman);
as a result of the comparison, if the calculated tentative assigned count is less than or equal to than (the surplus assignable count+deliverable count of the deliveryman), setting the calculated assigned count to the calculated tentative assigned count;
sorting the extracted delivery data on the basis of the postal code of the delivery data;
assigning the extracted delivery data to a deliveryman according to the calculated assigned count; and
transmitting the extracted delivery data to a mobile terminal associated with the deliveryman, at least in part, the extracted delivery data to cause the mobile terminal to transmit the customer address to a navigation system of a delivery vehicle, the navigation system configured to recognize multiple places corresponding to the customer address to determine a delivery route for delivering the gas cylinder.

8. The method according to claim 7, further comprising:
storing, in the delivery data storage unit, a delivered flag indicating whether or not delivery by a deliveryman is complete;
if the obtained total delivery count is greater than the total assigned count of the deliverymen, selecting postponed delivery data for which delivery is postponed from among the delivery data, and setting the delivered flag of the delivery data corresponding to the selected postponed delivery data to a value indicating delivery postponement.

9. The method according to claim 7, further comprising:
storing, in the deliveryman data storage unit, an allocation order indicating an order of assigning delivery data to deliverymen working for a delivery base; and
assigning, using the allocation order, the delivery data to deliverymen.

10. The method according to claim 9, further comprising:
storing, in customer data storage unit the customer ID and an installed count of gas cylinders;
extracting customer data from the customer data storage unit on the basis of the customer ID included in the delivery data; and
selecting postponed delivery data for which delivery is postponed from among the delivery data on the basis of the installed count of gas cylinders included in the extracted customer data.

11. The method according to claim 9, further comprising:
storing in the delivery data storage unit, a gas cylinder remaining amount by predicting a remaining amount in a gas cylinder on the basis of one of a past gas usage history, meter data, or gas cylinder delivery history; and
selecting postponed delivery data for which delivery is postponed from among the delivery data on the basis of the gas cylinder remaining amount included in the delivery data.

12. A non-transitory computer-readable storage medium storing computer-executable instructions that when executed cause a computer to perform operations for managing a delivery area in which a deliveryman deliver a gas cylinder filled with gas to a gas customer who receives a gas supply, the operations comprising:
extracting, on the basis of a specific delivery base identification code, deliveryman data including a delivery base identification code, a deliveryman identification code, a deliverable count of gas cylinders, and a surplus assignment coefficient;
extracting, leave data including a delivery base identification code, a deliveryman identification code, a scheduled leave date, and a leave type indicating one of an all-day off or a half-day off, on the basis of the specific delivery base identification code and a predetermined delivery due date, such that:
if the leave type of the extracted leave data indicates an all-day off, removing deliveryman data including a deliveryman identification code matching a deliveryman identification code included in the leave data from the extracted deliveryman data; or
if the leave type of the extracted leave data indicates a half-day off, halving a deliverable count of deliveryman data including a deliveryman identification code matching a deliveryman identification code included in the leave data in the extracted deliveryman data;
obtaining a deliverable count and a surplus assignable count of each deliveryman on the basis of the extracted deliveryman data, wherein the surplus assignable count is computed according to a first formula
surplus assignable count=(surplus assignment coefficient−1)*deliverable count;
calculating a total deliverable count by summing the obtained deliverable count, and calculating a total surplus assignable count by summing the obtained surplus assignable count;
extracting, delivery data including a delivery base identification code, a customer ID, a postal code, a customer address, a delivery due date, and an exchange count, using the specific delivery base identification code and the predetermined delivery due date, and obtaining a total delivery count by summing the exchange count of the extracted delivery data;
comparing the calculated total deliverable count and the obtained total delivery count such that:
as a result of the comparison, if the obtained total delivery count is less than or equal to the calculated total deliverable count, calculating an assigned count for each deliveryman according to a second formula
assigned count=total delivery count/total deliverable count*deliverable count of deliveryman; or
as a result of the comparison, if the obtained total delivery count is greater than the calculated total deliverable count, calculating a tentative assigned count for each deliveryman according to a third formula
tentative assigned count={(total delivery count−total deliverable count)/total surplus assignable count*surplus assignable count of deliveryman}+deliverable count of deliveryman;
comparing the calculated tentative assigned count to (the surplus assignable count+deliverable count of the deliveryman) such that:
as a result of the comparison, if the calculated tentative assigned count is greater than (the surplus assignable count+deliverable count of the deliveryman), setting the calculated assigned count to (the surplus assignable count+deliverable count of the deliveryman); or
as a result of the comparison, if the calculated tentative assigned count is less than or equal to than (the surplus assignable count+deliverable count of the deliveryman), setting the calculated assigned count to the tentative assigned count;
sorting the extracted delivery data on the basis of the postal code of the delivery data;
assigning the extracted delivery data to a deliveryman according to the calculated assigned count; and
transmitting the extracted delivery data to a mobile terminal associated with the deliveryman, at least in part, the extracted delivery data to cause the mobile terminal to transmit the customer address to a navigation system of a delivery vehicle, the navigation system configured to recognize multiple places corresponding to the customer address to determine a delivery route for delivering the gas cylinder.

13. A delivery area management system for managing a delivery area in which a deliveryman deliver a gas cylinder filled with gas to a gas customer who receives a gas supply, the system comprising:
a processor;
a memory coupled to the processor, the memory containing storage units comprising:
a deliveryman data storage unit that stores a delivery base identification code, a deliveryman identification code a deliverable count of gas cylinders, and a surplus assignment coefficient;
a delivery data storage unit that stores a delivery base identification code, a customer ID, a postal code, a customer address, a delivery due date, and an exchange count;
a leave data storage unit that stores a delivery base identification code, a deliveryman identification code, a scheduled leave date, and a leave type indicating an all-day off or a half-day off;
data obtaining unit that
extracts, on the basis of a specific delivery base identification code, deliveryman data from the deliveryman data storage unit,
obtains the deliverable count of each deliveryman on the basis of the extracted deliveryman data,
uses the processor to calculate, on the basis of the extracted deliveryman data, a surplus assignable count for each deliveryman according to a first formula
surplus assignable count=(surplus assignment coefficient−1)*deliverable count,
uses the processor to calculate a total deliverable count of the specific delivery base by summing the obtained deliverable count,
uses the processor to calculate a total surplus assignable count of the specific delivery base by summing the calculated surplus assignable count, and
extracts delivery data from the delivery data storage unit on the basis of the specific delivery base identification code and the predetermined delivery due date, and obtains a total delivery count by summing the exchange count of the extracted delivery data;
a leave managing unit that
extracts leave data from the leave data storage unit on the basis of the specific delivery base identification code and the predetermined delivery due date, such that:
if the leave type of the extracted leave data indicates an all-day off, removes deliveryman data including a deliveryman identification code matching a deliveryman identification code included in the leave data from the extracted deliveryman data, and
if the leave type of the extracted leave data indicates a half-day off, halves the deliverable count of deliveryman data including a deliveryman identification code matching a deliveryman identification code included in the leave data in the extracted deliveryman data;
a count assigning unit that
compares the calculated total deliverable count and the obtained total delivery count, such that:
as a result of the comparison, if the obtained total delivery count is less than or equal to the calculated total deliverable count, calculates an assigned count for each deliveryman according to a second formula
assigned count=total delivery count/total deliverable count*deliverable count of deliveryman,
as a result of the comparison, if the obtained total delivery count is greater than the calculated total deliverable count, calculates a tentative assigned count for each deliveryman according to a third formula
tentative assigned count={(total delivery count−total deliverable count)/total surplus assignable count*surplus assignable count of deliveryman}+deliverable count of deliveryman,
as a result of the comparison, if the calculated tentative assigned count is greater than (the surplus assignable count+deliverable count of the deliveryman), sets the calculated assigned count to (the surplus assignable count+deliverable count of the deliveryman), or
as a result of the comparison, if the calculated tentative assigned count is less than or equal to than (the surplus assignable count+deliverable count of the deliveryman), sets the calculated assigned count to the tentative assigned count; and
a delivery data assigning unit that
sorts the extracted delivery data on the basis of the postal code of the delivery data,
assigns the extracted delivery data to a deliveryman according to the calculated assigned count; and
transmits the extracted delivery data to a mobile terminal associated with the deliveryman, at least in part, the extracted delivery data to cause the mobile terminal to transmit the customer address to a navigation system of a delivery vehicle, the navigation system configured to recognize multiple places corresponding to the customer address to determine a delivery route for delivering the gas cylinder.
